(19) United States
(12) Patent Application Publication
(10) Pub. No.: US 2014/0217256 A1
(43) Pub. Date: Aug. 7, 2014

(54) CUP CARRYING DEVICE

(71) Applicant: Thomas James Young, Laurel, MD (US)

(72) Inventor: Thomas James Young, Laurel, MD (US)

(21) Appl. No.: 14/173,518

(22) Filed: Feb. 5, 2014

Related U.S. Application Data
(60) Provisional application No. 61/760,939, filed on Feb. 5, 2013.

(51) Int. Cl. F16M 13/02; F16M 13/04

(52) U.S. Cl. CPC F16M 13/022; F16M 13/04
USPC 248/311.2

(57) ABSTRACT

A cup carrying device is provided. The cup carrying device may include a cup ring that is made of either a rigid or semi-rigid material. A basket may extend from the cup ring so that the cup ring forms an opening to the basket. The basket is sized to fit a beverage container within. The cup carrying device may further include an attachment component that is configured to attach to a support structure. Therefore, a user may secure the cup carrying device either to their person or a motorcycle for use with the beverage container.

### CROSS-REFERENCE TO RELATED APPLICATION

This application claims the benefit of priority of U.S. provisional application No. 61/760,939, filed Feb. 5, 2013, the contents of which are herein incorporated by reference.

### BACKGROUND OF THE INVENTION

The present invention relates to a cup carrying device and, more particularly, to a cup carrying device used while riding a motorcycle.

A motorcycle (also called a motorbike, bike, moto or cycle) is a two or three wheeled motor vehicle. Motorcycle design varies greatly to suit a range of different purposes: long distance travel, navigating urban traffic, cruising, sport, racing and off road riding. Currently, cup holders are not attached to motorcycles. Therefore, it is difficult and dangerous to carry a beverage while riding on a motorcycle.

As can be seen, there is a need for a device that secures a beverage while riding a motorcycle.

### SUMMARY OF THE INVENTION

In one aspect of the present invention, a cup carrying device comprises: a cup ring comprising a semi-rigid or rigid material; a basket extending from the cup ring, wherein the cup ring forms an opening leading into the basket, wherein the basket is sized to fit a beverage container within; and an attachment component attached to the cup ring and configured to attach to a support structure.

These and other features, aspects and advantages of the present invention will become better understood with reference to the following drawings, description and claims.

### BRIEF DESCRIPTION OF THE DRAWINGS

FIG. 1 is a perspective view of the present invention shown in use;

FIG. 2 is a perspective view of the present invention;

FIG. 3 is an exploded view of the present invention;

FIG. 4 is a front view of the belt of FIG. 1;

FIG. 5 is a rear view of the belt of FIG. 1;

FIG. 6 is a front view of the cup ring of FIG. 1;

FIG. 7 is a rear view of the cup ring of FIG. 1;

FIG. 8 is a front view of the attachment strap of FIG. 1;

FIG. 9 is a rear view of the attachment strap of FIG. 1;

FIG. 10 is a front view of the cup ring lock of FIG. 1;

FIG. 11 is a rear view of the cup ring lock of FIG. 1;

FIG. 12 is a front view of the basket straps of FIG. 1;

FIG. 13 is a rear view of the basket straps of FIG. 1;

FIG. 14 is a perspective view of an alternate embodiment of the present invention, shown in use;

FIG. 15 is an exploded view of an alternate embodiment of the present invention; and

FIG. 16 is a section view, taken along line 3-3 in FIG. 14.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a cup carrying device. The cup carrying device may include a cup ring that is made of either a rigid or semi-rigid material. A basket may extend from the cup ring so that the cup ring forms an opening to the basket. The basket is sized to fit a beverage container within. The cup carrying device may further include an attachment component that is configured to attach to a support structure. Therefore, a user may secure the cup carrying device either to their person or a motorcycle for use with the beverage container.

The present invention includes a beverage cup holder for motorcycle riders. The portable cup holder may be adjustable in size and may releasably attach to handle bars, a windshield, a belt or a leg. The cup holder may be positioned so that the driver does not have to take their eyes off of the road. The cup holder may be made with any suitable material, such as leather and vinyl, that may be stitched together into the appropriate straps. The present invention may further be decorated with rhinestones, logos, designs, colors, and the like. The portable cup holder may attached together with marine hook and loop fastener technology and may be further held together by adhesives, such as acrylic adhesive, rubber based adhesive, and combinations thereof. The material may have temperature rates between about −20° F. and about 180° F. The present invention may be used with motorcycles, sporting events, for fishing, hiking, camping, hunting and the like to transport and have access to beverages.

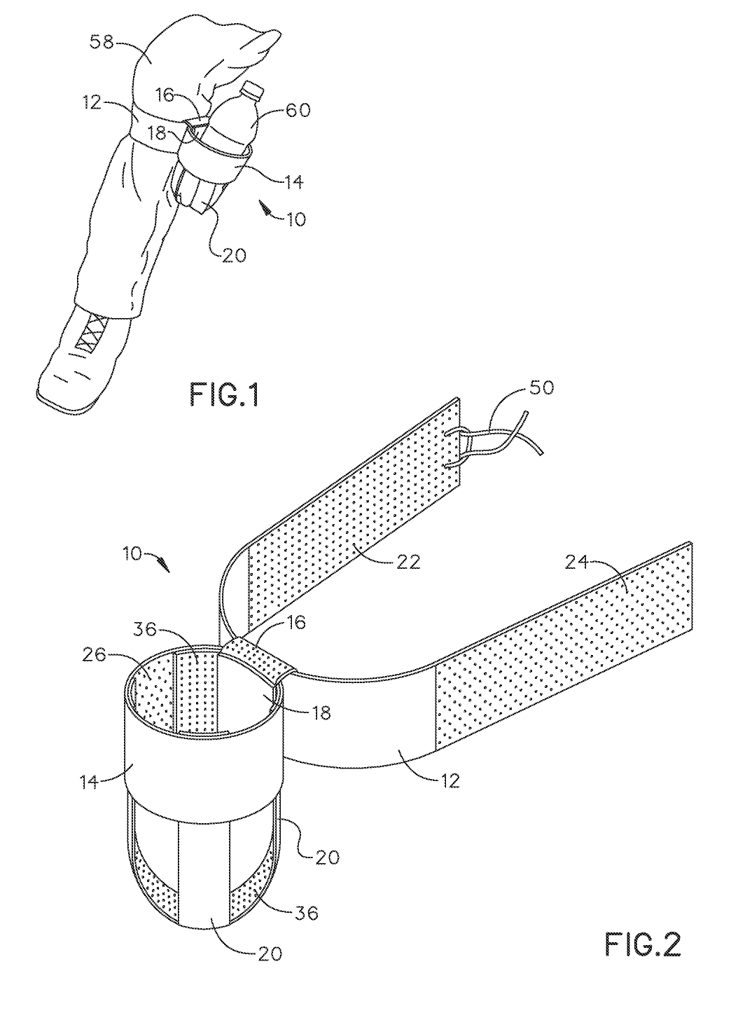

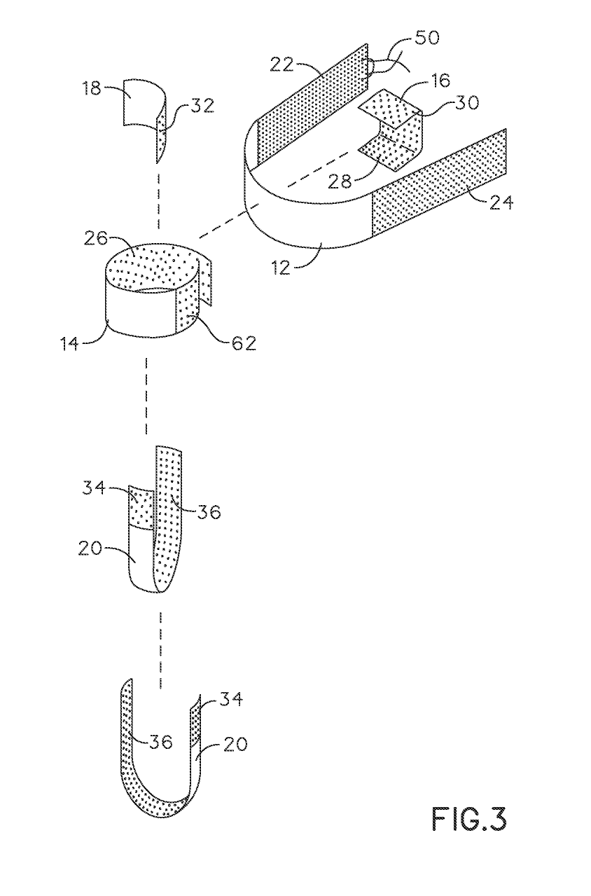

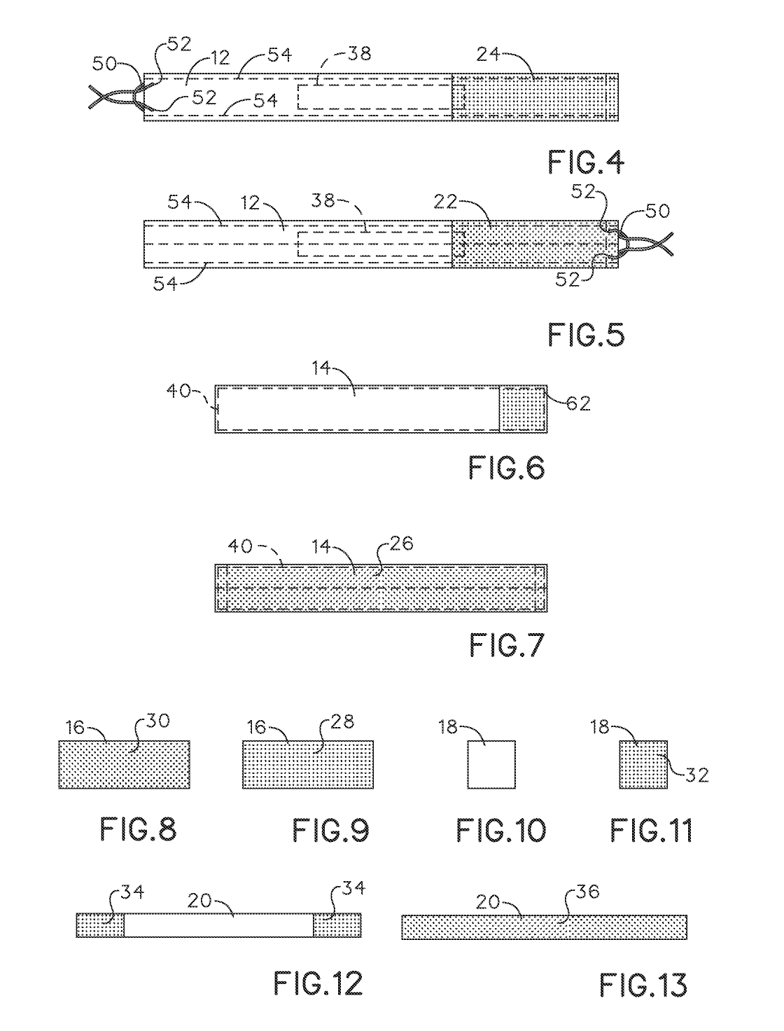

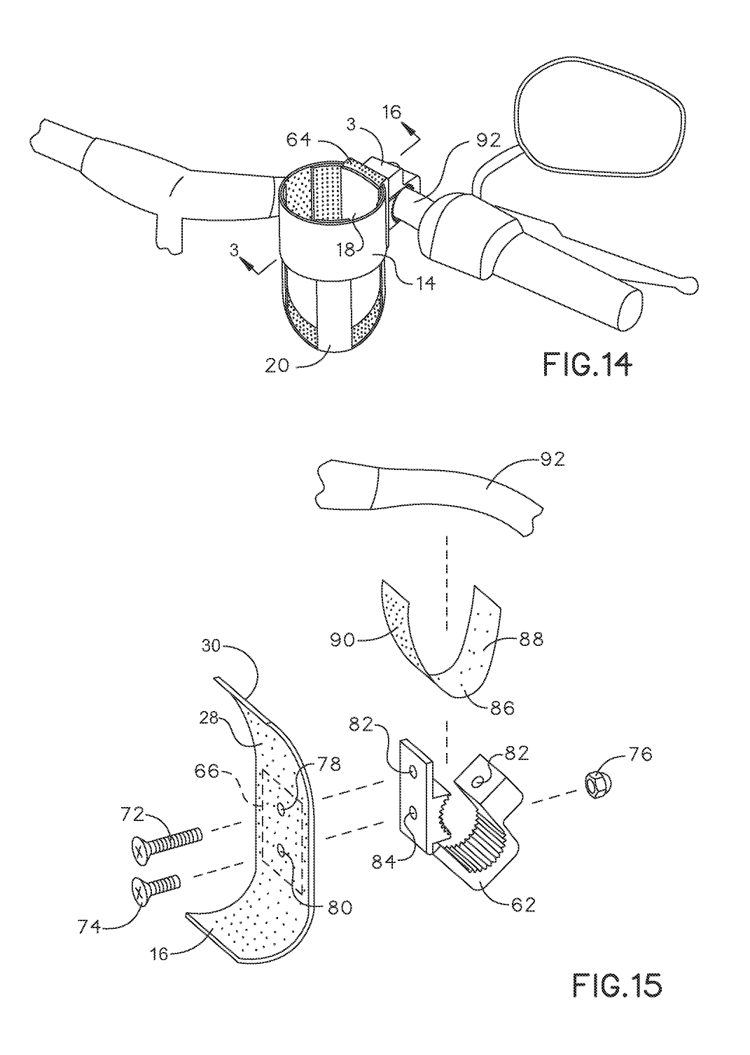

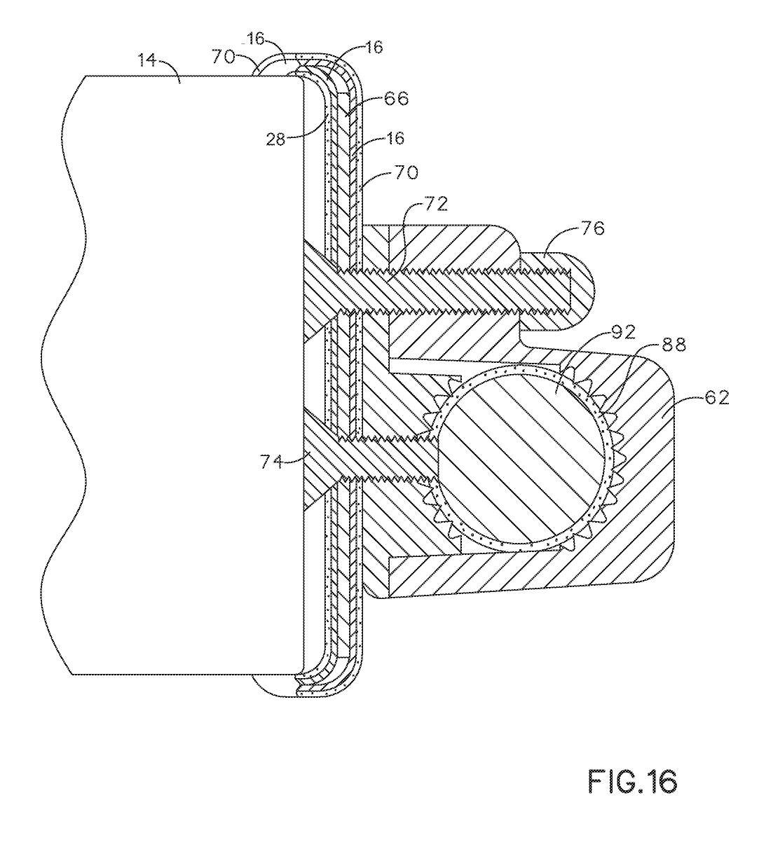

Referring to FIGS. 1 through 16, the present invention includes a cup carrying device 10. The cup carrying device 10 includes a cup ring 14 at least partially made of a semi-rigid or rigid material 40 and may include a seam 40. The present invention may further include at least one basket strap 20 attached to the cup ring 14 and substantially perpendicular relative to the cup ring 14. For example, the present invention may include a plurality of basket straps 20, such as two basket straps 20. The basket straps 20 may form a basket sized to fit a beverage container 60. The present invention may further include an attachment strap 16. The attachment strap 16 may attach the cup ring 14 to a support structure.

In certain embodiments, the cup ring 14, the basket straps 20, and the attachment strap 16 are releasably attachable to one another by hook and loop fasteners. In such embodiments, the cup ring 14 includes an inside surface and an outside surface. The inside surface may include a hook and loop fastener 26. The outside surface may include a hook and loop fastener 62 attachable to the hook and loop fastener 26 on the inside surface. The basket straps 20 may include an inside surface, an outside surface, a first end, and a second end. The first end and the second end of the outside surface may include a hook and loop fastener 34 that mate and attach to the hook and loop fastener 26 of the cup ring 14. The inside surface of the basket straps 20 may also include a hook and loop fastener 36. The attachment strap 16 may also include an outside surface and an inside surface. The inside surface may include a hook and loop fastener 28 that mates and attaches to the hook and loop fastener 26 of the cup ring 14. The outside surface of the attachment strap 16 may include a hook and loop fastener 30 that mates and attaches to the hook and loop fastener 28 of the inside surface of the attachment strap 16.

In certain embodiments, the hook and loop fastener 34 of the first end and the second end of a first basket strap 20 and a second basket strap 20 attaches to the hook loop fastener 26 of the inside surface of the cup ring 14. The first and second basket straps 20 forms intersecting loops and thereby forms a basket to support the container 60. The attachment strap 16 may wrap around the cup ring 16 and an exposed portion of the hook loop fastener 26 of the inside surface of the cup ring 14 attaches to the hook and loop fastener 28 of the inside surface of the attachment strap 16. The attachment strap 16 may further wrap around the support structure and a first end of the attachment strap 16 may connect with a second end of the attachment strap 16, thereby securing the cup ring 14 to the support structure. For further securement, a cup ring lock 18 may releasably attachable to the outside surface of the attachment strap 16. The cup ring lock 18 may include an inside surface with a hook and loop fastener 32 that mates and attaches to the hook and loop fastener 30 of the outside surface of the attachment strap 16.

In certain embodiments, support structure may include a belt 12 that may releasably attach to an arm or a leg 58 of a user. The belt 12 may include an outside surface, an inside surface, a first end and a second end. The belt 12 may include seams 54. The inside surface of the first end may include a hook and loop fastener 22 and the outside surface of the second end may include a hook and loop fastener 24 that mates and attaches to the hook and loop fastener 22 of the first end. The belt 12 may further include pull cords 50 through pull holes 52 for further securement of the belt 12 to the user. The attachment strap 16 may wrap around and releasably attach to the belt, thereby securing the cup ring 14 to the belt 12.

In certain embodiments, the support structure may include a clamp 62 that is releasably attachable to a handlebar 92 of a bike. The clamp 62 may include a first portion and a second portion. The first portion may partially wrap around the handlebar 92 and the second portion may wrap around the remaining exposed portion of the handlebar 92. The first portion and second portion may be secured together to secure the clamp 62 to the handlebar 92. An inner portion of the clamp that wraps around the handle bar 92 may include a plurality of splines for additional gripping. In certain embodiments, a handlebar pad 86 with an adhesive 88 may be sandwiched between the splines and the handlebar 92 to add additional grip.

In certain embodiments, the first portion may include at least one bolt hole 82 that may align with at least one bolt hole 82 on the second portion. The attachment strap 16 may also include a bolt hole 78 that aligns with the bolt hole 82 of the first and second portions. A bolt 72 may be driven through the bolt holes 78, 82 to secure the attachment strap 16 to the clamp 62. In such embodiments, the attachment strap 16 may include a semi-rigid or rigid portion 66, in which the bolt hole 78 runs through for additional support. A nut 76 may be secured to the end of the bolt 72 to secure the attachment strap 16, the first portion, and the second portion together. In certain embodiments, an additional bolt hole 80 may run through the attachment strap 16 and align with an additional bolt hole 84 in the second portion. A second bolt or screw 74 may be driven into the bolt holes 80, 84 for additional securement.

It should be understood, of course, that the foregoing relates to exemplary embodiments of the invention and that modifications may be made without departing from the spirit and scope of the invention as set forth in the following claims.

What is claimed is:

1. A cup carrying device comprising:
a cup ring comprising a semi-rigid or rigid material;
a basket extending from the cup ring, wherein the cup ring forms an opening leading into the basket, wherein the basket is sized to fit a beverage container within; and
an attachment component attached to the cup ring and configured to attach to a support structure.

2. The cup carrying device of claim 1, wherein the basket is formed by a plurality of basket straps.

3. The attachment component of claim 2, wherein the attachment component is an attachment strap.

4. The cup carrying device of claim 3, wherein the cup ring, the plurality of basket straps, and the attachment strap are releasably attachable to one another.

5. The cup carrying device of claim 4, wherein the cup ring comprises an inside surface and an outside surface, wherein the inside surface comprises a hook and loop fastener.

6. The cup carrying device of claim 5, wherein the plurality of basket straps comprise an inside surface, an outside surface, a first end, and a second end, wherein at least the first end and the second end of the outside surface comprise a hook and loop fastener configured to mate and attach to the hook and loop fastener of the cup ring.

7. The cup carrying device of claim 5, wherein the attachment strap comprises an outside surface and an inside surface, wherein the inside surface comprises a hook and loop fastener configured to mate and attach to the hook and loop fastener of the cup ring, and the outside surface comprises a hook and loop fastener configured to mate and attach to the inside surface of the attachment strap.

8. The cup carrying device of claim 7, further comprising a cup ring lock releasably attachable to the outside surface of the attachment strap.

9. The cup carrying device of claim 3, wherein the support structure comprises a belt comprising an outside surface, an inside surface, a first end and a second end, wherein the inside surface of the first end comprises a hook and loop fastener and the outside surface of the second end comprises a hook and look fastener configured to mate with and attach to the hook and loop fastener of the first end, wherein the attachment strap wraps around and releasably attaches to the belt.

10. The cup carrying device of claim 3, wherein the support structure comprises a clamp releasably attachable to a handlebar of a bike.

11. The cup carrying device of claim 10, wherein the clamp comprises: a first portion configured to partially wrap around the handlebar; a second portion attachable to the first portion and wrapping around an exposed portion of the handlebar, wherein the second portion comprises at least one bolt hole, wherein the attachment strap comprises at least one bolt hole that aligns with the at least one bolt hole of the second portion, wherein the attachment strap and the clamp are attached to one another via a bolt through the bolt holes.
